(19) United States
(12) Patent Application Publication
(10) Pub. No.: US 2016/0368119 A1
(43) Pub. Date: Dec. 22, 2016

(54) Self-Adjusting Clamp System

(71) Applicant: Kreg Enterprises, Inc., Huxley, IA (US)

(72) Inventor: Scott L. Clark, Boone, IA (US)

(21) Appl. No.: 15/188,151

(22) Filed: Jun. 21, 2016

Related U.S. Application Data
(60) Provisional application No. 62/182,688, filed on Jun. 22, 2015.

(51) Int. Cl. B25B 7/18; B25B 7/12

(52) U.S. Cl. CPC B25B 7/18; B25B 7/123

(57) ABSTRACT

A self-adjusting clamp system having an upper clamp arm connected to an upper handle and a lower clamp arm connected to a lower handle. The lower handle includes a hollow interior that defines an axis of reciprocation. A wedge lock and activator wedge are positioned within the hollow interior and separated by a separation plate. As the upper handle and lower handle are opened and closed, the wedge lock and activator wedge slide within the hollow interior of the lower handle along the axis of reciprocation as the separation plate slides vertically within a slot in the lower handle. The wedge lock, separation plate and activator wedge work in cooperation with one another to lock and unlock the clamp arms on workpieces of various widths automatically and without user-applied adjustments.

### FIELD OF THE INVENTION

This invention relates generally to hand tools. More specifically, and without limitation, this invention relates to clamp-type hand tools.

### BACKGROUND OF INVENTION

An endless array of hand tools exist. Each tool specifically designed for a specific use or an array of specific uses. One category of hand tools are known as clamps or hand clamps.

Traditionally, clamps are used to hold two workpieces together, or to hold one or more workpieces stationary so as to make it easier to perform additional processes on the workpiece(s) such as drilling, gluing, cutting, screwing or the like.

One common form of a hand clamp is conventionally known as vice-grips. These clamping devices commonly include a pair of clamping arms connected to a pair of handles. An adjustment mechanism is connected to the tool that adjusts the distance between the clamping arms when the handles are in a closed position. While these tools are effective at providing an adjustable hand clamp, they are inefficient and unappealing to use because the adjustment mechanism must be manually adjusted to adapt the tool for varying workpiece thicknesses. The adjustment mechanism requires the user to guess-and-check the setting, which often requires multiple iterations of adjustments, many resulting in the force being too great or too little, or the clamping arms being too close together or too far apart, before stumbling upon the right adjustment.

In an attempt to resolve the inconveniences and inefficiencies of manually adjusted hand clamps, various self-adjusting clamps have been developed. Examples of these clamps include those taught in U.S. Pat. No. 6,776,072 to Poole, U.S. Pat. No. 8,613,433 to Poole, and U.S. Pat. Pub. No. 2015/0033514 to Poole. While the designs presented in these patents and patent applications provide some advantages, they also suffer from various deficiencies. Namely, existing self-adjusting clamps are finicky, complex, expensive to manufacture, prone to malfunction, prone to wear out, complicated to assemble, difficult to manufacture in a robust manner, and provide inconsistent performance, among countless other disadvantages.

Therefore, for the reasons stated above, and for other reasons stated below which will become apparent to those skilled in the art upon reading and understanding the specification, claims and drawings, there is a need in the art for an improved self-adjusting clamp system.

Thus, an object of the invention is to provide a self-adjusting clamp system that improves upon the present state of the art.

Another object of the invention is to provide an improved self-adjusting clamp system that is simple to use.

Yet another object of the invention is to provide a self-adjusting clamp system that is easy to use.

Another object of the invention is to provide an improved self-adjusting clamp system that can be used in association with a work bench or as a free hand tool.

Yet another object of the invention is to provide a self-adjusting clamp system that is safe to use.

Another object of the invention is to provide an improved self-adjusting clamp system that provides new and additional ways of using a clamp.

Yet another object of the invention is to provide a self-adjusting clamp system that allows for added flexibility of use.

Another object of the invention is to provide an improved self-adjusting clamp system that can be used with a wide array of work processes.

Yet another object of the invention is to provide a self-adjusting clamp system that can be used in a wide array of industries.

Another object of the invention is to provide an improved self-adjusting clamp system that can be used with a wide array of work piece thicknesses, quickly and easily.

Yet another object of the invention is to provide a self-adjusting clamp system that has a robust design.

Another object of the invention is to provide an improved self-adjusting clamp system that is forgiving.

Yet another object of the invention is to provide a self-adjusting clamp system that is durable.

Another object of the invention is to provide an improved self-adjusting clamp system that has a long useful life.

Yet another object of the invention is to provide a self-adjusting clamp system that has an intuitive design.

Another object of the invention is to provide an improved self-adjusting clamp system that improves the speed and ease of performing work processes.

These and other objects, features, or advantages of the invention will become apparent from the specification and claims.

### SUMMARY OF THE INVENTION

A self-adjusting clamp system having an upper clamp arm connected to an upper handle and a lower clamp arm connected to a lower handle. The lower handle includes a hollow interior that defines an axis of reciprocation. A wedge lock and activator wedge are positioned within the hollow interior and separated by a separation plate. As the upper handle and lower handle are opened and closed, the wedge lock and activator wedge slide within the hollow interior of the lower handle along the axis of reciprocation as the separation plate slides vertically within a slot in the lower handle. The wedge lock, separation plate and activator wedge work in cooperation with one another to lock and unlock the clamp arms on workpieces of various widths automatically and without user-applied adjustments.

### BRIEF DESCRIPTION OF THE DRAWINGS

FIG. 1 is a perspective view of a self-adjusting clamp system;

FIG. 2 is a perspective exploded view of the self-adjusting clamp system of FIG. 1;

FIG. 3 is a side elevation view of the self-adjusting clamp system of FIG. 1;

FIG. 4 is a side cut-away elevation view of the self-adjusting clamp system of FIG. 1, the view showing the clamp system in a closed position;

FIG. 5 is a side cut-away elevation view of the self-adjusting clamp system of FIG. 1, the view showing the clamp system in an open position;

FIG. 6 is an end cut-away elevation view of the self-adjusting clamp system of FIG. 1, the view showing the wedge lock positioned within the hollow interior of the lower handle, the view showing the radius of curvature of the upper surface of the wedge lock being smaller than the radius of curvature of the hollow interior of the lower handle;

FIG. 7 is a side cut-away elevation view of the self-adjusting clamp system of FIG. 1, the view showing the clamping system in an open position and the first cam surface of the rearward end of the lever engaging the forward surface of the adjustment pin connected to the wedge lock;

FIG. 8 is a side cut-away elevation view of the self-adjusting clamp system of FIG. 1, the view showing the clamping system in closed position and the second cam surface of the rearward end of the lever engaging the forward surface of the adjustment pin connected to the wedge lock;

FIG. 9 is a side elevation view of the self-adjusting clamp system of FIG. 1, the view showing the clamping system in closed position, the view showing the stop surface of the upper handle engaging the cam surface of the lower handle in a condition where a thin workpiece is clamped as the stop surface on the upper handle is positioned near the forward end of the cam surface on the lower handle;

FIG. 10 is a side elevation view of the self-adjusting clamp system of FIG. 1, the view showing the clamping system in closed position, the view showing the stop surface of the upper handle engaging the cam surface of the lower handle in a condition where a thicker workpiece is clamped (as compared to FIG. 9) as the stop surface on the upper handle is positioned near the center end of the cam surface on the lower handle;

FIG. 11 is a side perspective view of a self-adjusting clamp system configured as a bar clamp; and

FIG. 12 is a side perspective view of a self-adjusting clamp system configured as a bench clamp.

### DETAILED DESCRIPTION OF THE INVENTION

In the following detailed description, reference is made to the accompanying drawings which form a part hereof, and in which is shown by way of illustration specific embodiments in which the invention may be practiced. These embodiments are described in sufficient detail to enable those skilled in the art to practice the invention, and it is to be understood that other embodiments may be utilized and that mechanical, procedural, and other changes may be made without departing from the spirit and scope of the invention(s). The following detailed description is, therefore, not to be taken in a limiting sense, and the scope of the invention is defined only by the appended claims, along with the full scope of equivalents to which such claims are entitled.

As used herein, the terminology such as vertical, horizontal, top, bottom, front, back, end and sides are referenced according to the views presented and the orientation and arrangement of parts. It should be understood, however, that the terms are used only for purposes of description, and are not intended to be used as limitations. Accordingly, orientation of an object or a combination of objects may change without departing from the scope of the invention.

With reference to the Figures, a self-adjusting clamp system 10 is presented (system 10 or clamp 10). The system 10 includes an upper clamp arm 12, a lower clamp arm 14, an upper clamp pad 16, a lower clamp pad 18, an upper handle 20, a lower handle 22, a wedge lock 24, a an activator wedge 26, a separation plate 28, a lever 30, a floor plate 32, an adjustment pin 34, an adjustment spring 36, a return spring 38, a guide pin 40 and a lever spring 42 among other components. Clamp 10 is formed of any suitable size, shape and design and serves the purpose of clamping one or more workpieces 44 together or in place. Clamp 10 extends from a forward end 46, or clamping end, and a rearward end 48.

Upper Clamp Arm:

Upper clamp arm 12 is formed of any suitable size, shape and design and serves to transition torque or pressure from upper handle 20 and lower handle 22 to workpiece 44. In the arrangement shown, as one example, upper clamp arm 12 includes a center section 50 that is generally elongated and extends laterally a length with a forward section 52 connected to the forward end of center section 50 and a rearward section 54 connected to the rearward end of center section 50. Forward section 52 extends downward from center section 50 in a generally perpendicular manner to the length of center section 50. Rearward section 54, however, extends downward from center section 50 at a slight rearward angle. Forward section 52 and rearward section 54 serve to recess center section 50 so as to allow clamp arms 12, 14 to reach around portions of non-flat workpieces 44.

In one arrangement, upper clamp arm 12 is formed of a generally flat and planar piece of material. While this arrangement is simple to manufacture and strong, it is material-intensive and heavy. In another arrangement, upper clamp arm 12 is skeletonized, or includes a plurality or arrangement of recesses 56 and ribs 58 that provide the benefits of material savings and weight savings while still providing substantial strength and rigidity. In some arrangements, the skeletonized design may provide improved strength and rigidity over using a solid piece of material.

An upper clamp pad 16 is connected to forward end 46 of upper clamp arm 12 (the lower end forward section 52). Upper clamp pad 16 is formed of any suitable size, shape and design and serves to provide an area of greater surface area to distribute the clamping pressure generated by clamp 10 so as not to mark or damage workpiece 44. In the arrangement shown, upper clamp pad 16 is generally planar in shape when viewed from the side, and generally circular in shape when viewed from above or below. The lower surface of upper clamp pad 16 is flat, for engaging workpiece 44. A bracket 60 is connected to the upper surface of upper clamp pad 16 and includes a pair of opposing arms 62 that are positioned in approximate parallel spaced relation to one another and sized and shaped to receive the end of forward section 52 of upper clamp arm 12 there between. Bracket 60 and the end of forward section 52 include an opening that receives clamp pad pin 64 therein that pivotally holds upper clamp pad 16 to upper clamp arm 12. Clamp pad pin 64 is any form of a connecting device that pivotally connects two components together such as a screw, bolt, rivet, axle or the like. The pivotal connection between upper clamp pad 16 and upper clamp arm 12 allows the plane of upper clamp pad to adjust to varying thicknesses of workpiece 44.

Lower Clamp Arm:

Lower clamp arm 14 is formed of any suitable size, shape and design and serves to transition torque or pressure from upper handle 20 and lower handle 22 to workpiece 44. In the arrangement shown, as one example, lower clamp arm 14 includes a center section 50 that is generally elongated and extends laterally a length with a forward section 52 connected to the forward end of center section 50 and a rearward section 54 connected to the rearward end of center section 50. Forward section 52 extends upward from center section 50 in a generally perpendicular manner to the length of center section 50. Rearward section 54, however, extends upward from center section 50 at a slight rearward angle. Forward section 52 and rearward section 54 serve to recess center section 50 so as to allow clamp arms 12, 14 to reach around portions of non-flat workpieces 44.

In one arrangement, lower clamp arm 14 is formed of a generally flat and planar piece of material. While this arrangement is simple to manufacture and strong, it is material-intensive and heavy. In another arrangement, lower clamp arm 14 is skeletonized, or includes a plurality or arrangement of recesses 56 and ribs 58 that provide the benefits of material savings and weight savings while still providing substantial strength and rigidity. In some arrangements, the skeletonized design may provide improved strength and rigidity over using a solid piece of material.

A lower clamp pad 18 is connected to forward end 46 of lower clamp arm 14 (the upper end forward section 52). Lower clamp pad 18 is formed of any suitable size, shape and design and serves to provide an area of greater surface area to distribute the clamping pressure generated by clamp 10 so as not to mark or damage workpiece 44. In the arrangement shown, lower clamp pad 18 is generally planar in shape when viewed from the side, and generally circular in shape when viewed from above or below. The upper surface of lower clamp pad 18 is flat, for engaging workpiece 44. A bracket 60 is connected to the lower surface of lower clamp pad 18 and includes a pair of opposing arms 62 that are positioned in approximate parallel spaced relation to one another and sized and shaped to receive the end of forward section 52 of lower clamp arm 14 there between. Bracket 60 and the end of forward section 52 include an opening that receives clamp pad pin 64 therein that pivotally holds lower clamp pad 18 to lower clamp arm 14. Clamp pad pin 64 is any form of a connecting device that pivotally connects two components together such as a screw, bolt, rivet, axle or the like. The pivotal connection between lower clamp pad 18 and lower clamp arm 14 allows the plane of lower clamp pad 18 to adjust to varying thicknesses of workpiece 44.

Upper Handle:

Upper handle 20 is formed of any suitable size, shape and design and serves as a lever an operator can grasp to operate clamp 10. In the arrangement shown, as one example, upper handle 20 is a generally elongated member that extends from a forward end 66 to a rearward end 68. Upper handle 20 includes an upper surface 70 that generally curved or arcuate in nature so as to provide optimum user comfort. Curved upper surface 70 connects at its lower edge to a pair of opposing sides 72 that are generally planar and extend in approximate parallel spaced relation to one another and form a hollow center in upper handle 20 below upper surface 70.

Upper handle 20 is wider than upper clamp arm 12 and includes a pair of opposing connection arms 74 at forward end 66. Connection arms 74 are positioned in approximate parallel spaced relation to one another and are sized and shaped to receive a portion of upper clamp arm 12 there between in a pivotal manner. That is, connection arms 74 neck-in or angle inward from the wider sides 72 so as to match the width of upper clamp arm 12. Connection arms 74 include an opening therein that aligns with an opening in the rearward side of rearward section 54 of upper clamp arm 12. More specifically, connection arms 74 are aligned with a protrusion 76 in the upper rearward side of rearward section 54 of upper clamp arm 12. Protrusion 76 is positioned between the upper and lower ends of rearward section 54.

The connection between upper clamp arm 12 and the forward end 66 of upper handle 20 forms a first pivot point at a first pivot point pin 78. First pivot point pin 78 is any form of a connecting device that pivotally connects two components together such as a screw, bolt, rivet, axle or the like.

Upper handle 20 also includes a pair of opposing openings in sides 72 rearward of the rearward ends of connection arms 74 that receives a center pivot point pin 80 and forms a center pivot point. These openings align with an opening in the forward or upper end of lever 30 and as such center pivot point pin 80 extends through the forward end of lever 30, as well as sides 72 of upper handle 20, thereby pivotally connecting lever 30 to upper handle 20 at center pivot point. Center pivot point pin 80 is any form of a connecting device that pivotally connects two components together such as a screw, bolt, rivet, axle or the like.

Lower Handle:

Lower handle 22 is formed of any suitable size, shape and design and serves as a lever an operator can grasp to operate clamp 10. In the arrangement shown, as one example, lower handle 22 is a generally elongated member that extends from a forward end 82 to a rearward end 84. Lower handle 22 includes a center portion 86 that connects opposing handle sides 88. Handle sides 88 are generally flat and planar in shape when viewed from above or below or from their ends. In the arrangement shown, center portion 86 is generally arcuate or curves from one handle side 88 to the other handle side 88 in a generally curved, arcuate or semi-circular manner. When viewed from their end, handle sides 88 extend in approximate parallel spaced planar relation to one another with center portion 86 curving in a semi-circular manner from handle side 88 to handle side 88. Center portion 86 having a semi-circular upper surface and corresponding semi-circular lower surface.

A hollow interior 90 is defined within lower handle 22 between opposing handle sides 88 and below center portion 86. That is, hollow interior 90 has generally flat planar sides, defined by the interior surface of opposing handle sides 88, and a curved upper surface, defined by the lower surface of center portion 86. Hollow interior 90 defines an axis of reciprocation for the moving components that fit within hollow interior 90 and slide forward-and-back a reciprocation distance between the forward end 82 and rearward end 84 of lower handle 22.

Forward end 82 of lower handle 22 connects to the rearward end of lower clamp arm 14 by any manner, method or means. In one arrangement, as is shown, the forward end of handle sides 88 neck inward slightly to the approximate width of the rearward section 54 of lower clamp arm 14. In this arrangement, the rearward section 54 of lower clamp arm 14 is frictionally received between the forward end of handle sides 88 and the two components are connected by a plurality of pins 92. Pins 92 are any connecting device such as a bolt, rivet, screw, axle or the like. In the arrangement shown, three pins 92 are used, however any other number is hereby contemplated for use. As a plurality of pins 92 are used, the connection between lower handle 22 and lower clamp arm 14 is rigid or non-pivotal in nature. In another arrangement, lower clamp arm 14 and lower handle 22 are formed out of a single unitary piece of material such as by machining or casting or the like manufacturing processes. In yet another arrangement, instead of using pins 92 to connect lower handle 22 to lower clamp arm 14, the two components are adhered together such as through welding or the like processes.

An opening 94 is positioned in the handle sides 88 adjacent the forward end of lower handle 22 and the upper end of rearward section 54 of lower clamp arm 14. Opening 94 is positioned, sized and shaped to be aligned opening 96 in the lower end of rearward section 54 of upper clamp arm 12. Once aligned, opening 94 in handle sides 88 and opening 96 in the lower end of rearward section 54 of upper clamp arm 12 receive clamp arm pivot pin 98 there through such that the upper clamp arm 12 pivots with respect to the lower clamp arm 14 on the axis of rotation defined by clamp arm pivot pin 98. Upper clamp arm 12 opens and closes by pivoting on clamp arm pivot pin 98. Clamp arm pivot pin 98 is any form of a connecting device that pivotally connects two components together such as a screw, bolt, rivet, axle or the like.

Floor plate 32 is connected to the lower edge of the rearward side of handle sides 88 of lower handle 22. Floor plate 32 is generally flat and planar in shape and serves to connect the lower edge of opposing handle sides 88 thereby closing the bottom end of hollow interior 90.

Floor plate 32 is connected to lower handle 22 by any manner, method or means. In one arrangement, as is shown, the lower edge of handle sides 88 include a plurality of notches 100 therein in spaced alignment. In the arrangement shown, three notches 100 are shown, however, any number is hereby contemplated such as one, two, four, five or more. In this arrangement, floor plate 32 includes a corresponding number of tabs 102 that are sized and shaped to fit within notches 100 with tight and close tolerances. Once tabs 102 are inserted within notches 100, floor plate 32 is affixed to lower handle 22 by any manner, method or means such as by welding, spot welding, bolting, screwing, adhering by other manner, connecting by any other manner, or any other manner method or means or combination thereof. Alternatively, lower handle 22 and floor plate 32 are formed of a single continuous or monolithic piece which is formed by stamping, pressing, punching, or the like processes or a combination thereof. Alternatively, lower handle 22 and floor plate 32 are formed of a single continuous or monolithic piece which is formed by machining, casting, printing, or the like processes or a combination thereof.

Once installed, the flat, or generally flat or planar upper surface of floor plate 32 defines the bottom surface of hollow interior 90. In one arrangement, the generally flat upper surface of floor plate 32 is positioned in approximate parallel spaced alignment to the length of hollow interior 90 and/or the axis of reciprocation. In another arrangement, the generally flat upper surface of floor plate 32 is positioned at a slight angle to the length of hollow interior 90 and/or the axis of reciprocation, such that the plane of floor plate 32 angles away from the length of hollow interior 90 and/or the axis of reciprocation as the floor plate 32 extends toward rearward end 84 of lower handle 22. That is, said another way, the plane of the floor plate 32 angles downward and away from the center portion 86 of lower handle 22 as floor plate 32 extends from the forward end 82 of lower handle 22 to the rearward end 84 of lower handle 22. This slight angle provides an increasing amount of room for the components positioned within the hollow interior 90 as they move further towards the rearward end 84 of lower handle 22 which improves functioning of the system 10 and allows for greater ease when clamping workpieces 44 of varying thickness.

In one arrangement, the plane of floor plate 32 angles away from the length of hollow interior 90 and/or the axis of reciprocation at an angle of between one degree and parallel. In another arrangement, the plane of floor plate 32 angles away from the length of hollow interior 90 and/or the axis of reciprocation at an angle of between half a degree and parallel. In yet another arrangement, the plane of floor plate 32 angles away from the length of hollow interior 90 and/or the axis of reciprocation at an angle of between a quarter of a degree and parallel. In yet another arrangement, the plane of floor plate 32 angles away from the length of hollow interior 90 and/or the axis of reciprocation at an angle of between a tenth of a degree and parallel. In yet another arrangement, the plane of floor plate 32 angles away from the length of hollow interior 90 and/or the axis of reciprocation at an angle of between a hundredth of a degree and parallel. In one arrangement, it has been tested with success when the plane of floor plate 32 angles away from the length of hollow interior 90 and/or the axis of reciprocation at an angle of approximately six hundredths of a degree.

In one arrangement, it has been tested with success when the plane of floor plate 32 angles away from the length of hollow interior 90 and/or the axis of reciprocation at an angle of approximately seven hundredths of a degree. It has also been tested with success when the plane of floor plate 32 angles away from the length of hollow interior 90 and/or the axis of reciprocation at an angle of approximately five hundredths of a degree. As such, it is hereby contemplated that an angle in the range of two tenths of a degree and one hundredth of a degree is hereby contemplated as a range for use. It is also hereby contemplated that an angle in the range of fifteen hundredths of a degree and two hundredths of a degree is hereby contemplated as a range for use. It is also hereby contemplated that an angle in the range of twelve hundredths of a degree and two hundredths of a degree is hereby contemplated as a range for use. It is also hereby contemplated that an angle in the range of one tenth of a degree and three hundredths of a degree is hereby contemplated as a range for use. It is also hereby contemplated that an angle in the range of nine hundredths of a degree and three hundredths of a degree is hereby contemplated as a range for use. It is also hereby contemplated that an angle in the range of nine hundredths of a degree and four hundredths of a degree is hereby contemplated as a range for use. It is also hereby contemplated that an angle in the range of eight hundredths of a degree and four hundredths of a degree is hereby contemplated as a range for use. It is also hereby contemplated that an angle in the range of eight hundredths of a degree and six hundredths of a degree is hereby contemplated as a range for use. It is also hereby contemplated that an angle in the range of six hundredths of a degree and four hundredths of a degree is hereby contemplated as a range for use. However, any other angle, or range of angles is hereby contemplated for use.

Floor plate 32 also includes a stop arm 104. Stop arm 104 is formed of any suitable size, shape and design and serves to provide a forward most stop for the components positioned within hollow interior 90. In one arrangement, as is shown, stop arm 104 is a protrusion extending upward approximate the forward end of floor plate 32. In the arrangement shown, stop arm 104 is cut or punched out of the material of floor plate 32 itself, and then the stop arm 104 is bent into place thereby saving the need for a separate piece to form stop arm 104. In an alternative arrangement, floor plate 32 with protruding stop arm 104 is machined out of a single piece of material. In yet another alternative arrangement stop arm 104 is a separate piece of material attached to floor plate 32 by any manner, method or means such as screwing, bolting, welding, spot welding, adhering or the like. In yet another alternative arrangement, stop arm 104 is formed out of the material of another component of the system 10, such as, for example, handle sides 88.

The upper edges of handle sides 88 include cam surface 106. Cam surface 106 is positioned in the upper edge of handle sides 88 rearward of where the lower handle 22 connects to lower clamp arm 14 and forward of where center portion 86 terminates. Cam surface 106 of lower handle 22 serves as a stop for upper handle 20 when in a clamped or closed position. More specifically, upper handle 20 includes a stop surface 108 which is formed of the lower surface of upper handle 20 just below center pivot point pin 80. This portion of the upper handle 20 extends below the other portions of upper handle and as such it is the first portion to engage lower handle 22 when in a closed position. Stop surface 108 itself is rounded or arcuate in nature, and therefore can be described itself as a cam surface.

As clamp 10 clamps workpieces 44 of varying thicknesses, the point at which stop surface 108 of upper handle 20 engages the upper surface of lower handle 22 moves. The thinner the workpiece 44 the further forward the stop surface 108 of upper clamp arm 20 engages the cam surface 106 of lower clamp arm 22 between the forward end 110 of cam surface 106 and the rearward end 112 of cam surface 106. In contrast, the thicker the workpiece 44 the further rearward the stop surface 108 of upper clamp arm 20 engages the cam surface 106 of lower clamp arm 22 between the forward end 110 of cam surface 106 and the rearward end 112 of cam surface 106. The curvature of camp surface 106 ensures that regardless of the thickness of workpiece 44, the stop surface 108 engages the cam surface 106 at approximately the same amount of pressure, or at approximately the same amount of over-center condition, as is further described herein.

Wedge Lock:

Wedge lock 24 is formed of any suitable size, shape and design and serves to automatically lock and unlock clamp 10 in concert with the other components within hollow interior 90 of lower handle 22. In the arrangement shown, as one example, wedge lock 24 has a generally elongated body having a rounded upper surface 114 that connects to opposing sidewalls 116. Sidewalls 116 are generally flat and planar and extend in approximate parallel spaced alignment to one another.

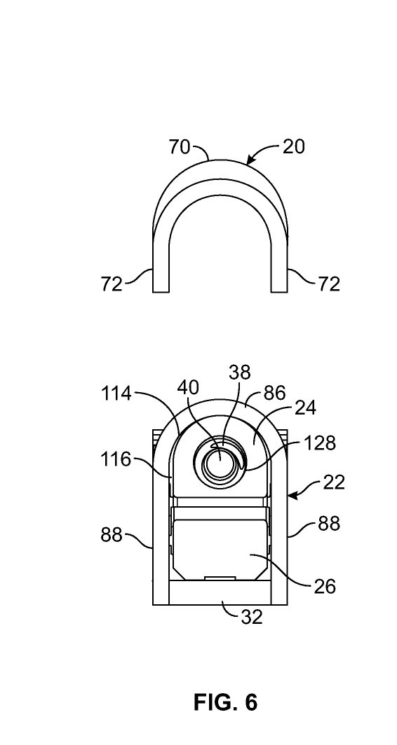

Upper surface 114 and sidewalls 116 are sized and shaped to fit within hollow interior 90 of lower handle 22 with close tolerances while allowing minimal friction when sliding along the axis of reciprocation. As is shown best in FIG. 6, the radius of curvature of the upper surface 114 of wedge lock 24 is smaller than the radius of curvature of the inner surface or lower surface of center portion 86 of lower handle 22. By slightly under-sizing the radius of curvature of the upper surface 114 of wedge lock 24 this allows or facilitates wedge lock 24 to self-center within the hollow interior 90 along the axis of reciprocation. Also, by slightly under-sizing the radius of curvature of the upper surface 114 of wedge lock 24 this reduces the amount of friction between the wedge lock 24 and the upper curved surface of hollow interior 90 as less surface area is in contact between wedge lock 24 and hollow interior 90, thereby improving the function of clamp 10.

Similarly, the width of wedge lock 24 between sidewalls 116 is slightly less than the width of hollow interior 90 between the interior surface of opposing handle sides 88. When wedge lock 24 is in position within hollow interior 90 of lower handle 22 the sidewalls 116 of wedge lock 24 are positioned in approximate parallel spaced alignment to the interior surfaces of opposing handle sides 88. By slightly under sizing the width of wedge lock 24 as compared to the width of hollow interior 90, this reduces friction between wedge lock 24 and hollow interior 90, thereby improving the function of clamp 10.

The lower surface of wedge lock 24 includes a step 118 positioned at the forward end of wedge lock 24. An angled wall 120 is positioned rearward of step 118 and extends at a slight downward angle as it extends from step 118 towards the rearward side of wedge lock 24 before terminating at the rearward end of wedge lock 24.

The forward end of wedge lock 24 includes a threaded bore that threadably receives adjustment pin 34. Adjustment pin 34 is formed of any suitable size, shape and design and serves to adjust the effective lateral length of wedge lock 24 so as to adjust the clamping pressure of clamp 10. In one arrangement, as is shown, adjustment pin 34 includes a threaded shaft 122 connected to a head 124 that is wider than shaft 122 that terminates in a generally flat face 126. The rounded exterior surface of head 124 is serrated or roughened so as to increase friction and gripping and to allow for easier rotation by a user. When adjustment pin 34 is threaded into wedge lock 24, adjustment spring 36 is positioned around threaded shaft 122 and between the rearward side of head 124 and the forward side of wedge lock 24 thereby applying a spring bias there between to help hold adjustment pin 34 in place during use.

The rearward end of wedge lock 24 includes bore 128 therein. Bore 128 is sized and shaped to receive the forward end of return spring 38. The rearward end of return spring 38 is positioned around and held in place by guide pin 40. Guide pin 40 connects at its rearward end to guide pin plate 130. Guide pin plate 130 includes tabs in its outward edges that are sized and shaped to be held within notches 132 approximate the rearward end of handle sides 88 of lower handle 22. When assembled with return spring 38 within bore 128 of wedge lock 24 and guide pin plate 130 positioned within notches 132 of lower handle 22, return spring 38 urges wedge lock forward within hollow interior 90 along the axis of reciprocation.

Separation Plate:

Separation plate 28 is formed of any suitable size, shape and design and serves to keep wedge lock 24 and activator wedge 26 in spaced relation to one another as they reciprocate forward-and-back along the axis of reciprocation within hollow interior 90 of lower handle 22. In the arrangement shown, as one example, separation plate 28 is generally planar in shape with a flat upper surface positioned in parallel spaced alignment to a flat bottom surface. Separation plate 28 is generally square or rectangular in shape when viewed from above or below, and includes a pair of tabs 132 that extend outward from opposing sides of separation plate 28. These tabs 134 are generally square or rectangular in shape themselves and are configured to be slidably received within slot 136 in handle sides 88 of lower handle 22.

Slot 136, when viewed from the side, is generally rectangular in shape and therefore allows the tabs 134 of separation plate 28 to slide vertically up and down therein. When positioned within hollow interior 90 of lower handle 22, separation plate 28 is positioned at an angle to the length of hollow interior 90 of lower handle 22 and/or to the axis of reciprocation. In the arrangement shown, separation plate 28 is positioned such that the forward end of separation plate 28 is above the rearward end of separation plate. That is, the separation plate 28 extends at a downward angle as it extends rearward, as compared to length of hollow interior 90 of lower handle 22 and/or to the axis of reciprocation. To match this downward angle, slot 136 is angled in a corresponding manner.

Activator Wedge:

Activator wedge 26 is formed of any suitable size, shape and design and serves to automatically lock and unlock clamp 10 in concert with the other components within hollow interior 90 of lower handle 22. In the arrangement shown, as one example, activator wedge 26 includes an elongated flat bottom surface 138, a pair of arms 140 connected to the forward end of the activator wedge 26 and an upper surface that includes a flat section 142 positioned just forward of an angled section 144 before terminating at its rearward end.

Bottom surface 138 is generally flat and planar and when activator wedge 26 is positioned within hollow interior 90 of lower handle 22, bottom surface 138 is positioned in sliding engagement with the flat upper surface of floor plate 32.

Arms 140 extend upward from activator wedge 26 and include a space there between as well as an opening there through. The space between arms 140 is sized and shaped to receive the lower rearward end of lever 30, and the opening in arms 140 is sized and shaped to be aligned with the opening in the lower rearward end of lever 30. Once aligned, the openings in arms 140 and the lower rearward end of lever 30 receives a third pivot point pin 146 and forms a third pivot point. Third pivot point pin 146 is any form of a connecting device that pivotally connects two components together such as a screw, bolt, rivet, axle or the like. The third pivot point allows the angle of lever 30 to adjust compared to the angle of activator wedge 26.

The angled section 144 activator wedge 26 is sized and shaped to align with the plane formed by the bottom surface of separation plate 28. In this arrangement, the upper angled surface 144 of activator wedge 26, the upper and lower surfaces of separation plate 28 and the lower wall 120 of wedge lock 24 are in approximate planar alignment to one another. Furthermore, the plane of the upper angled surface 144 of activator wedge 26 is in approximate parallel sliding engagement with the plane of the lower surface of the separation plate 28; and similarly, the plane of the upper surface of separation plate 28 is in approximate parallel sliding engagement with the plane of the lower wall 120 of wedge lock 24.

In this arrangement, at the beginning of a clamping operation, as the activator wedge 26 slides rearward, this causes the separation plate 28 to slide upward within slot 136 and simultaneously wedge lock 24 slides rearward in like fashion. This arrangement facilitates automatic clamping of workpieces 44 of varying thickness.

Lever Spring:

Lever spring 42 is formed of any suitable size, shape and design. In the arrangement shown, lever spring 42 connects at its forward end to the rearward side of upper clamp arm 12 and at its rearward end to the lever 30. In this way, lever spring 42 helps to return upper clamp arm 12 into an open position and pull activator wedge 26 forward within hollow interior 90.

Lever:

Lever 30 is formed of any suitable size, shape and design. In the arrangement shown, as one example, lever 30 is an elongated member that extends from a forward end 156 to a rearward end 158. In the arrangement shown, lever 30 has a generally flat upper and lower edge, includes rounded ends and is generally planar in shape. The forward end 156 of lever 30 is pivotally connected to the upper handle 20 at center pivot point pin 80 (center pivot point). The rearward end 158 of lever 30 is pivotally connected to the arms 140 of activator wedge 26 at third pivot point pin 146 (third pivot point).

Rearward end 158 of lever 30 also includes first cam surface 160 and second cam surface 162 therein. First cam surface 160 is positioned above second cam surface 162. First cam surface 160 comes to a sharper point or has a smaller radius of curvature than second cam surface 162. First cam surface 160 and second cam surface 162 engage the wedge lock 24, or more specifically the forward face 126 of adjustment pin 34 during an opening and closing operation. In one arrangement, as is shown, a recess, waist or narrower section is positioned between first cam surface 160 and second cam surface 162 that separate the two cam surfaces from one another. In an alternative arrangement, no recess, waist or narrower section 163 is positioned between first cam surface 160 and second cam surface 162 and instead in this arrangement the radius of curvature of the first cam surface 160 connects to the radius of curvature of the second cam surface 162.

In one arrangement, the rearward end 158 of lever 20 narrows. That is, in one arrangement the outward sides of lever 30 angle inward as they approach first cam surface 160 from second cam surface 162. Said another way, the sides or width of lever 30 narrow as they extend from second cam surface 162 upward toward first cam surface 160. This causes the rounded end of first cam surface 160 to be narrower than it would be otherwise which can provide increased accuracy and control of movement. In another arrangement, the outward sides of lever 30 angle inward as they approach second cam surface 162. In yet another arrangement, the outward sides of lever 30 angle inward as they approach both first cam surface 160 and second cam surface 162. Adjusting the width of first cam surface 160 and/or second cam surface 162 provides increased accuracy and control of movement and operation. Varying the width of these cam surfaces 160, 162 may be particularly well suited for various applications, such as various sized clamping devices 10, various sized work pieces, various clamping pressure and/or various work pieces.

In operation, when the upper clamp arm 12 is in an open position, first cam surface 160 of lever 30 engages the forward face 126 of adjustment pin 34. As the upper handle 20 is depressed and moves closer to lower handle 22, this causes the forward and upper end of lever 30 connected to upper handle 20 to move downward as the lever 30 slides rearward. As the rearward end 158 of lever 30 moves rearward this simultaneously causes the activator wedge 26 to slide rearward within hollow interior 90 as well as forces wedge lock 24 to move rearward by first cam surface 160 pushing upon the forward face 126 of adjustment pin 34.

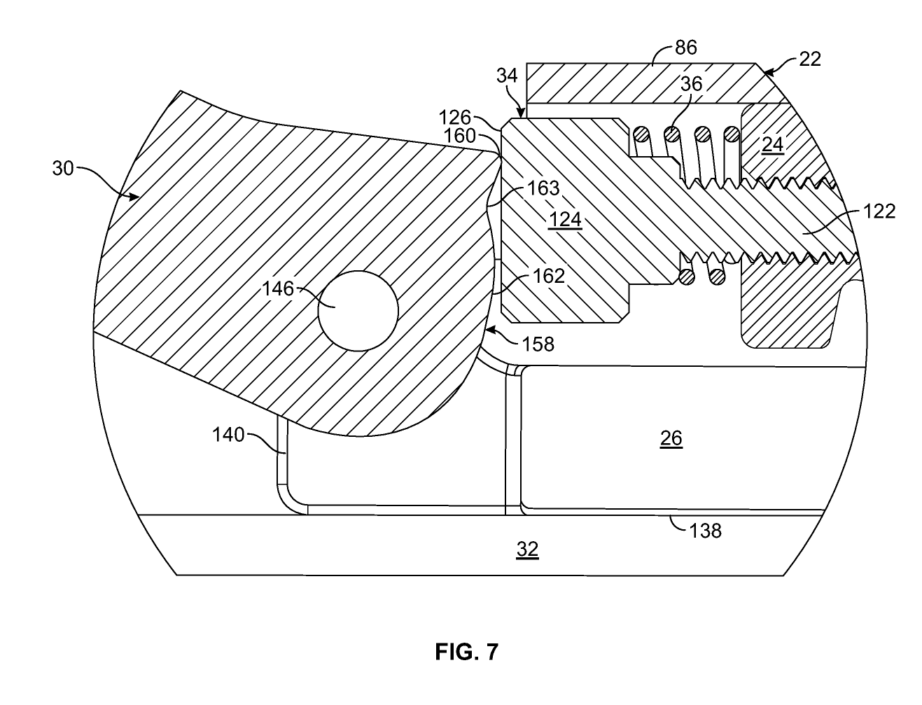

As the lever 30 continues to move rearward as the upper handle 20 is depressed the first cam surface 160 rotates on the forward face 126 of adjustment pin 34. This arrangement is shown in FIG. 7, where the first cam surface 160 engages the adjustment pin 34.

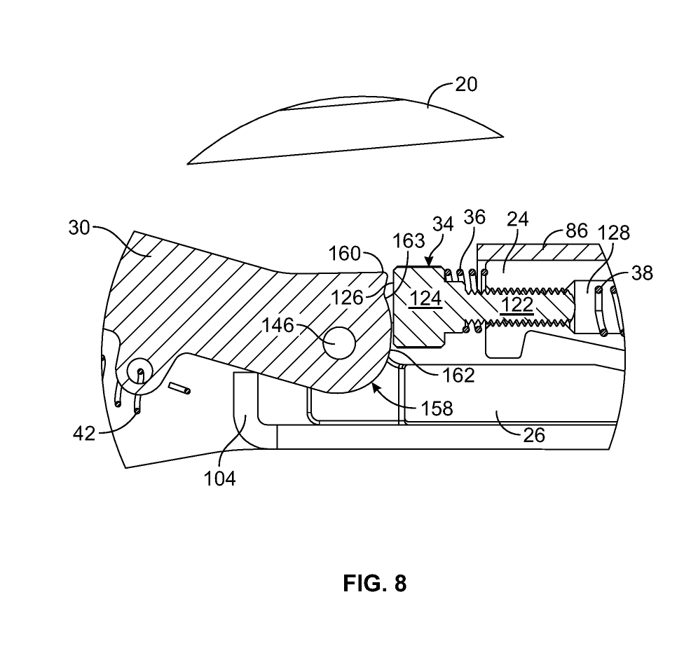

This continues as the upper handle 20 is lowered until the angle of lever 30 causes the engagement between first cam surface 160 and face 126 of adjustment pin 34 to transition to engagement between the second cam surface 162 and face 126 of adjustment pin 34. This occurs near the end of the clamping operation, and is shown in FIG. 8. At this point, lever 30 forces activator wedge 26 rearward while return spring 38 forces wedge lock 24 forward, thereby locking clamp 10 in a clamping position.

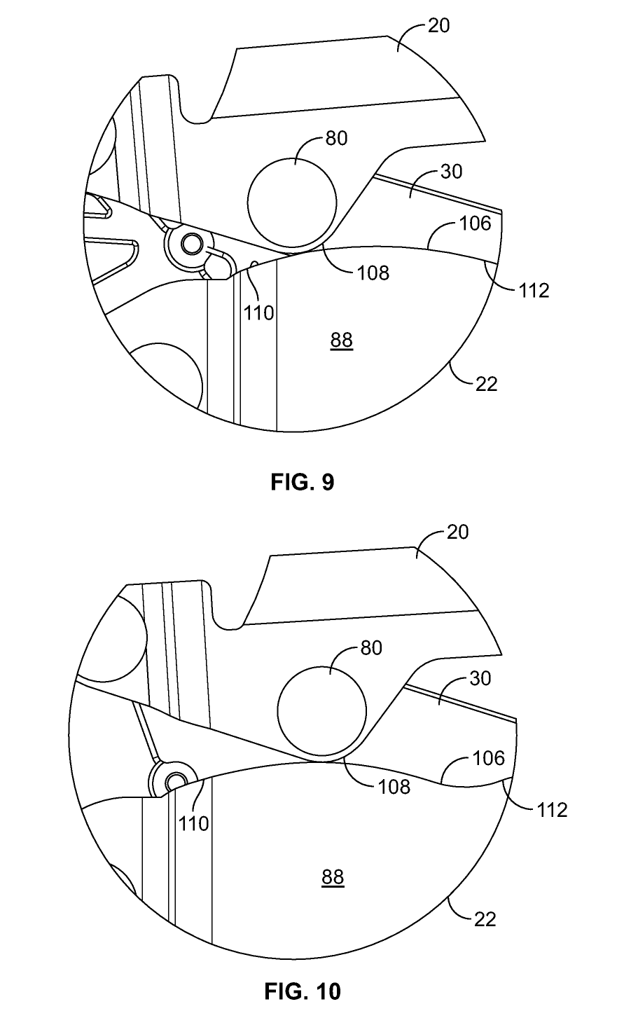

Simultaneously, or approximately simultaneously, upon arriving at a clamping position, the stop surface 108 of upper handle 20 engages the cam surface 106 in the upper edge of handle sides 88 of lower handle 22 (as is shown in FIGS. 9 and 10). When in a clamping position, the stop surface 108 of upper handle 20 engages the cam surface 106 in the upper edge of handle sides 88 of lower handle 22 the three pivot points 78, 80, 146 are position in an over-center condition. That is, in a clamping position, the center pivot point 80 travels a short distance past, or is positioned just below, the plane or axis between the first pivot point 78 and third pivot point 146. This over-center condition of center pivot point 80 helps to hold the clamp 10 in a clamped position. The curvature of the cam surface 106 in the upper surface of handle sides 88 of lower handle 22 ensures that the over-center condition occurs consistently throughout the range of workpiece thicknesses. That is, cam surface 106 ensures that the amount or distance center pivot point 80 is over-center as compared to the first pivot point 78 and third pivot point 146 is the same or similar regardless of the thickness or workpiece 44. That is, regardless of where the stop surface 108 of upper handle 20 engages the cam surface 106 of lower handle 22 (which corresponds to the workpiece thickness), the amount or distance center pivot point 80 is over-center as compared to the first pivot point 78 and third pivot point 146 is the same or similar. To open clamp 10, the upper handle 20 is raised. This pulls the center pivot point out of its over-center condition. In addition, as the upper handle 20 is raised, engagement between the second cam surface 162 and face 126 of adjustment pin 34 transitions back to engagement between the first cam surface 160 and face 126 of adjustment pin 34. As the upper handle 20 continues to be raised, after the first cam surface 160 engages the face 126 of adjustment pin 24, the first cam surface 160 will slightly force the adjustment pin 34 and wedge lock 24 rearward thereby freeing or breaking free the wedge lock 24. Once this occurs, activator wedge 26, separation plate 28 and wedge lock 24 are again free to slide within hollow interior 90 of lower handle 22.

Thin Work Piece Clamping Example:

When clamping a thin work piece, such as for example, a quarter inch piece of material, the user sets the adjustment pin 34 to the desired clamping pressure. Next, the work piece is placed between the upper clamp pad 16 and the lower clamp pad 18 and the upper handle 20 is moved closer to the lower handle 22. As the upper handle 20 is depressed and moves closer to lower handle 22, this causes the forward and upper end of lever 30 which is connected to upper handle 20 to move downward. Initially, in an open position, first cam surface 160 of lever 30 engages the forward face 126 of adjustment pin 34. When the upper clamp pad 16 and lower clamp pad 18 engage the workpiece and the upper handle 20 is further depressed, this causes the forward end of lever 30 to move further downward and rearward. As the rearward end 158 of lever 30 moves rearward this simultaneously causes the activator wedge 26 to slide rearward within hollow interior 90 as well as forces wedge lock 24 to move rearward by first cam surface 160 pushing upon the forward face 126 of adjustment pin 34. As the activator wedge 26 moves rearward, this causes separation plate 28 to rise within slot 136.

As the rearward end of lever 30 continues to move rearward and the forward end of lever 30 continues to lower as the upper handle 20 is depressed the first cam surface 160 rotates on the forward face 126 of adjustment pin 34. This rotation continues as the upper handle 20 is lowered until the angle of lever 30 causes the engagement between first cam surface 160 and face 126 of adjustment pin 34 to transition to engagement between the second cam surface 162 and face 126 of adjustment pin 34. This occurs near the end of the clamping operation. At this point, lever 30 forces activator wedge 26 rearward while return spring 38 forces wedge lock 24 forward. At this point, a locking engagement is formed between the upper surface of floor plate 32 and the lower surface of the center portion 86 of lower handle 22. That is, the activator wedge 26, separation plate 28 and wedge lock 24 are in locked engagement or wedged engagement with one another in the space between upper surface of floor plate 32 and the lower surface of the center portion 86 of lower handle 22.

The amount of tension or pressure between the activator wedge 26, separation plate 28 and wedge lock 24 is affected by the position or adjustment of adjustment pin 34. Similarly, the amount of tension or pressure required to close upper handle 20 with respect to lower handle 22 is affected by the position or adjustment of adjustment pin 34. Similarly, the amount of tension or pressure exerted between upper clamp pad 16 and lower clamp pad 18 is affected by the position or adjustment of adjustment pin 34.

Simultaneously, or approximately simultaneously, upon arriving at a clamping position, the stop surface 108 of upper handle 20 engages the cam surface 106 in the upper edge of handle sides 88 of lower handle 22. When in a clamping position, the stop surface 108 of upper handle 20 engages the cam surface 106 in the upper edge of handle sides 88 of lower handle 22 the three pivot points 78, 80, 146 are position in an over-center condition. Due to the workpiece being thin in this example, the stop surface 108 of upper handle 20 engages the cam surface 106 in the upper edge of handle sides 88 of lower handle 22 near the forward end of the cam surface 106.

Thick Work Piece Clamping Example:

When clamping a thick work piece, such as for example, a 2×4 piece of material, using the same user-set adjustment of the adjustment pin 34 identified above with respect to the thin work piece example, essentially the same process is repeated as is described with respect to the thin work piece example. In contrast, due to the increased thickness of the work piece, the upper clamp pad 16 and lower clamp pad 18 engage the workpiece earlier in the closing process. Due to this earlier engagement, this causes the activator wedge 26 to slide further back within the hollow interior 90 of lower handle 22.

Due to the configuration of the activator wedge 26, separation plate 28 and wedge lock 24 approximately the same amount of locking pressure is formed between the upper surface of floor plate 32 and the lower surface of the center portion 86 of lower handle 22 as is generated in the thin work piece clamping example above. That is, the activator wedge 26, separation plate 28 and wedge lock 24 are in locked engagement or wedged engagement with one another in the space between upper surface of floor plate 32 and the lower surface of the center portion 86 of lower handle 22, however they are positioned further back within the hollow interior 90 of lower handle 22.

Similarly, upon arriving at a clamping position, the stop surface 108 of upper handle 20 engages the cam surface 106 in the upper edge of handle sides 88 of lower handle 22. Due to the workpiece being thicker in this example, the stop surface 108 of upper handle 20 engages the cam surface 106 in the upper edge of handle sides 88 of lower handle 22 further rearward or in the rearward end of the cam surface 106.

As is shown by these two examples, once the desired clamping pressure is set by the user by adjusting adjustment pin 34, the user can repeatably clamp workpieces of varying thickness without any further adjustment of the clamp 10. Due to the configuration of the components of the clamp 10, approximately the same clamping pressure is generated throughout the range of workpiece thicknesses. This arrangement saves the user time and frustration by avoiding the need to continually readjust the setting of the clamp when workpieces of different thickness are clamped.

Angle:

As is described herein, in one arrangement the generally flat upper surface of floor plate 32 is positioned at a slight angle to the length of hollow interior 90 and/or the axis of reciprocation, such that the plane of floor plate 32 angles away from the length of hollow interior 90 and/or the axis of reciprocation as the floor plate 32 extends toward rearward end 84 of lower handle 22. This angle provides slightly more room between the upper surface of floor plate 32 and the lower surface of center portion 86 of lower handle 22 as the components (activator wedge 26 and wedge lock 24 move rearward within the hollow interior 90. This slightly increasing amount of room helps to ensure that approximately consistent functioning and approximately consistent clamping pressure is generated across the range of workpiece thicknesses.

Bar Clamp Arrangement:

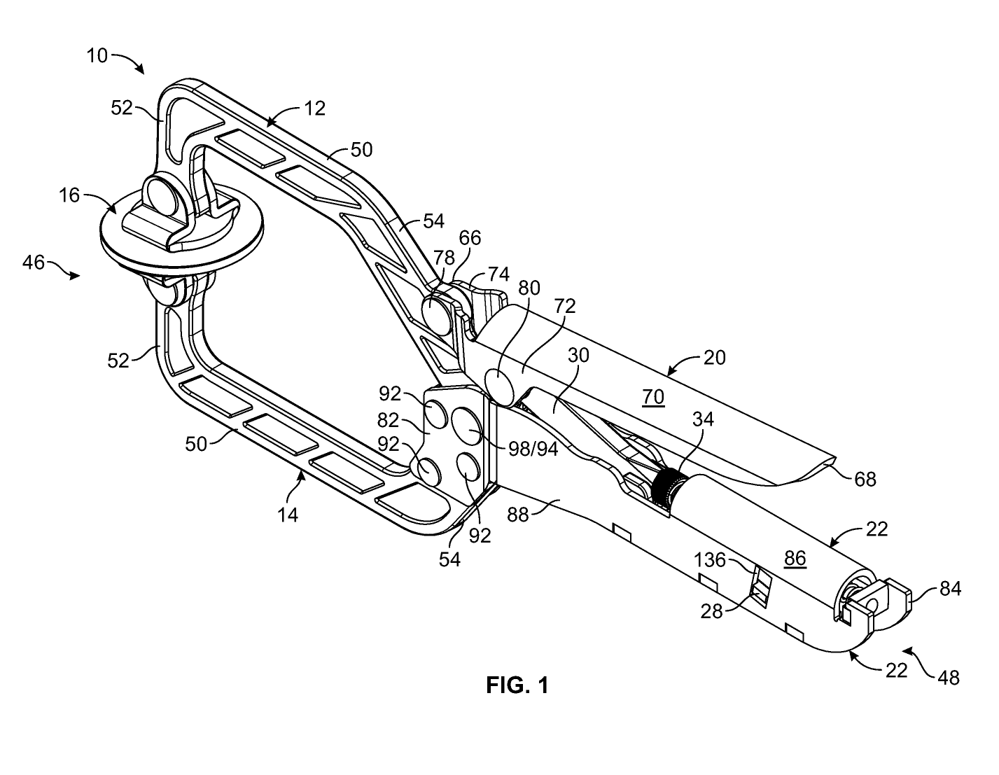

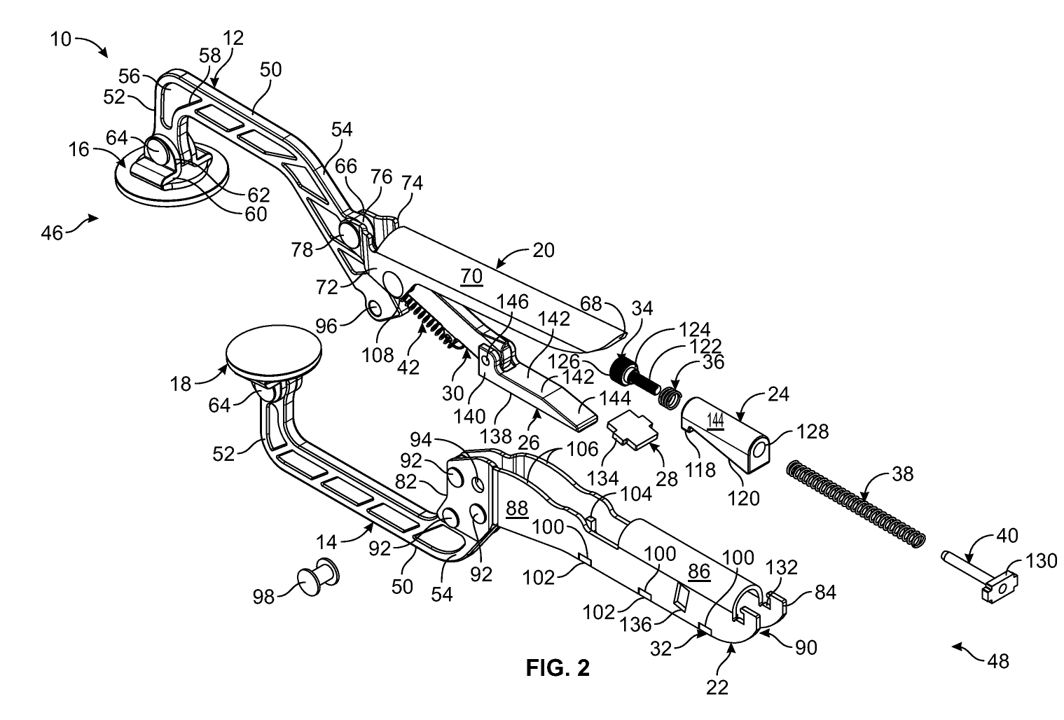

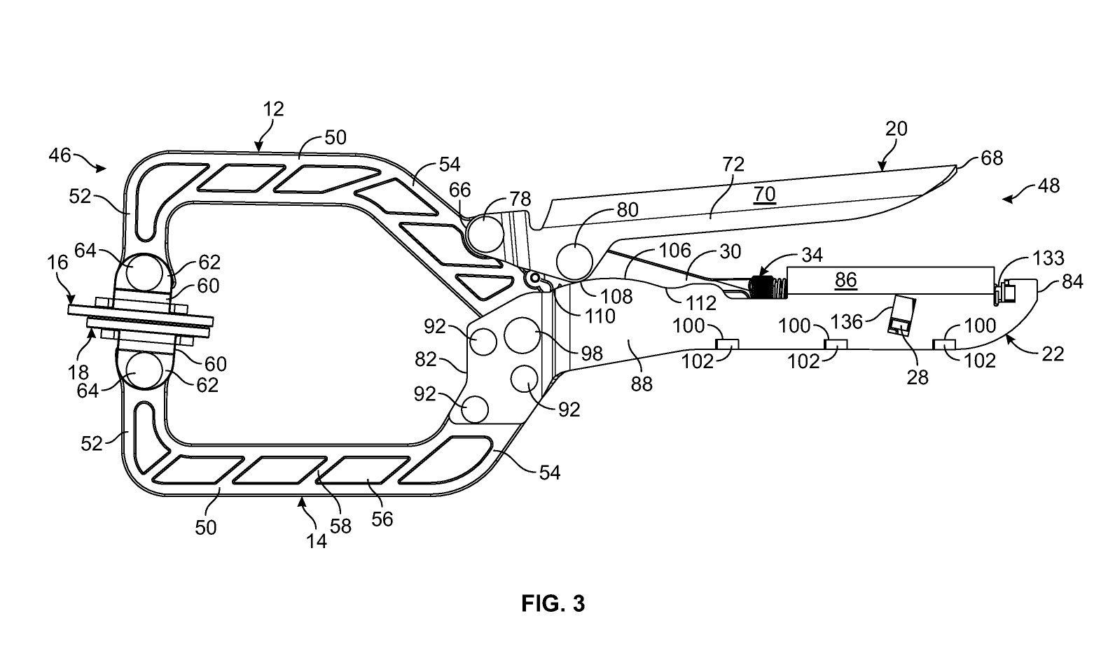

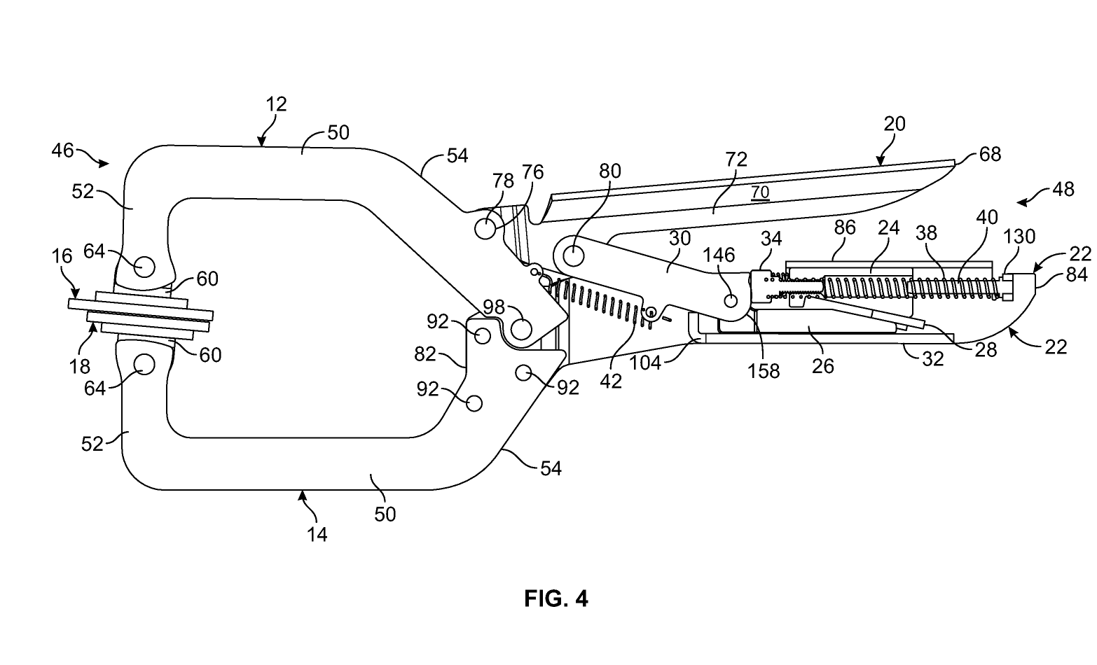

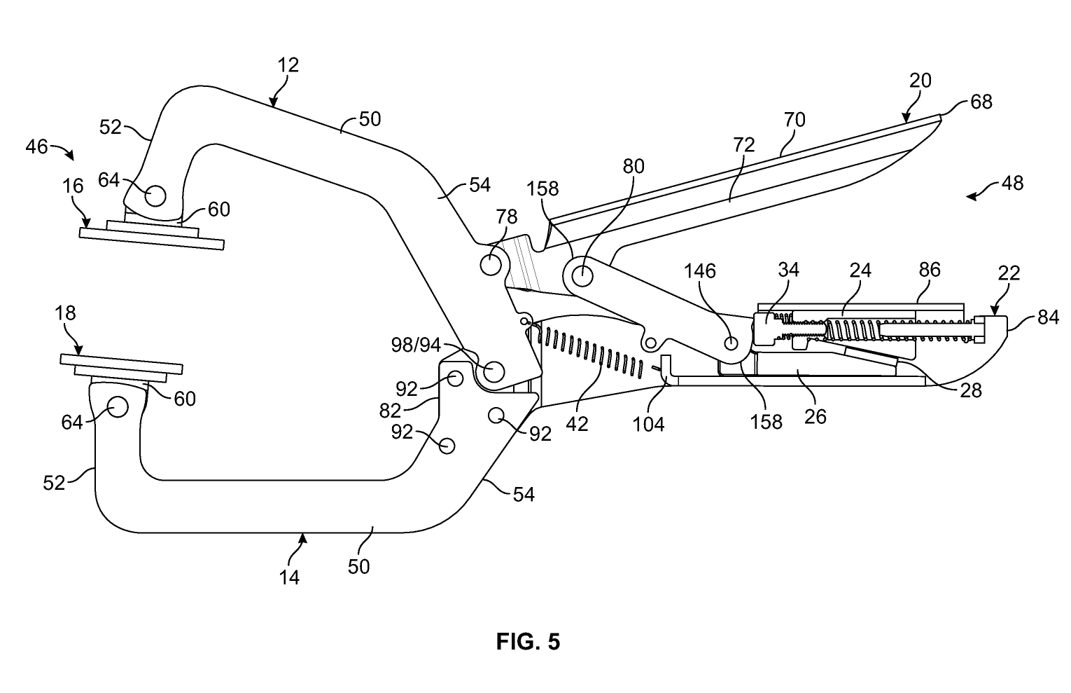

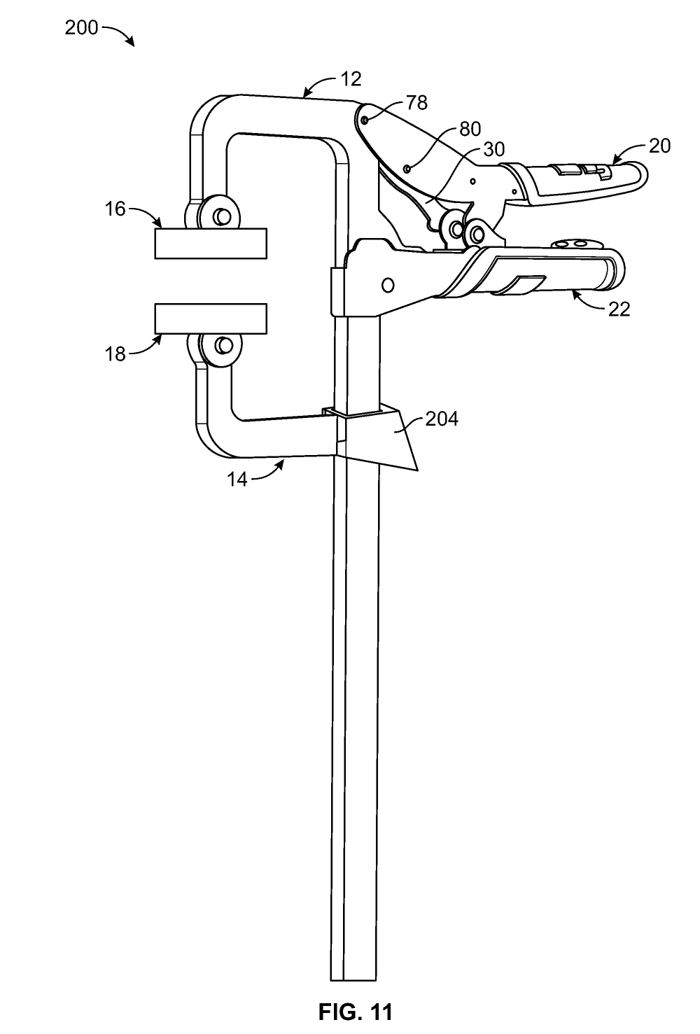

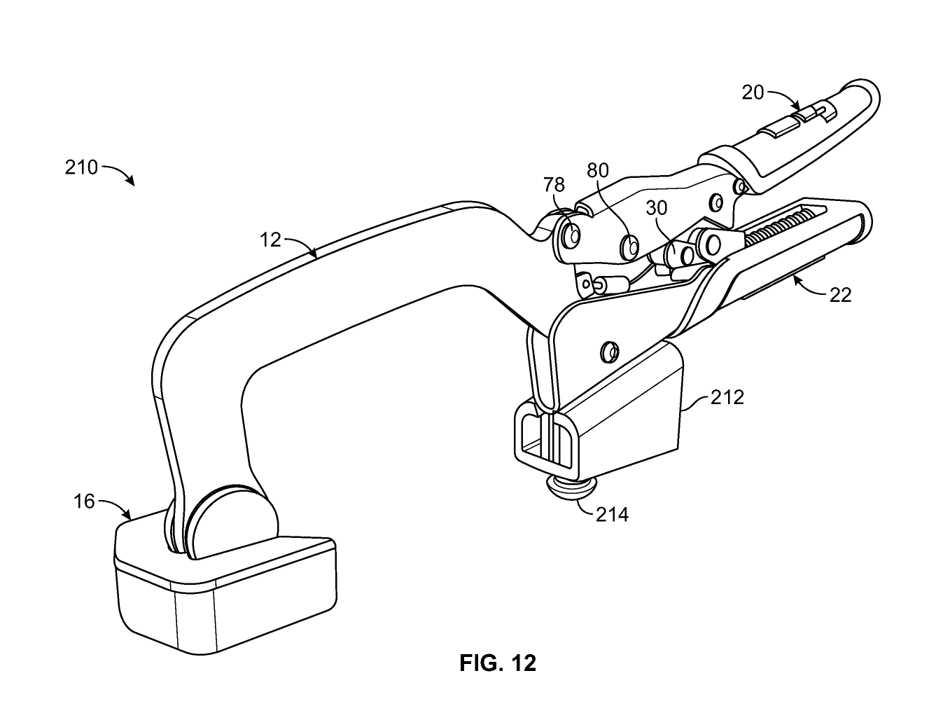

While FIGS. 1-6 show the clamp 10 as a free hand clamp system, it is hereby contemplated that the system presented herein is equally applicable to bar clamps. With reference to FIG. 11, one example of a bar clamp system 200 is presented. Bar clamp system 200 includes the similar features of an upper clamp arm 12, a lower clamp arm 14, an upper clamp pad 16, a lower clamp pad 18, an upper handle 20, a lower handle 22, a lever 30 as well as all the same internal components described herein such as the wedge lock 24, activator wedge 26, separation plate 28 and the like. As such, having the same or similar components as is described herein, bar clamp 200 opens and closes, locks and unlocks in the same or a similar manner to that described herein.

Bar clamp system 200 differs from the free hand clamp system in that the lower clamp arm 14 is adjustably connected to elongated bar 202. That is lower handle 20 and upper clamp arm 12 connect to elongated bar 202 at one end of bar 202 or in a fixed and/or pivotal manner and position. In contrast, lower clamp arm 14 connects to bar 202 in a slidable or positionable manner by connection member 204. In this way, lower clamp arm 14 can be moved to any position along the length of bar 202 by manipulating connection member 204. This enables bar clamp system 200 to clamp workpieces having a wide range of widths. Once lower clamp arm 14 is in position, the self-adjusting clamping mechanism of bar clamp 200 operates in a similar if not identical manner described above with respect to the free hand clamp system 10.

Bench Clamp Arrangement:

While FIGS. 1-6 show the clamp 10 as a free hand clamp system, and FIG. 11 shows the system as a bar clamp 200, it is hereby contemplated that the system presented herein is equally applicable to bench clamps. With reference to FIG. 12, as one example, a bench clamp system 210 is presented. Bench clamp system 210 includes the similar features of an upper clamp arm 12, an upper clamp pad 16, an upper handle 20, a lower handle 22, a lever 30 as well as all the same internal components described herein such as the wedge lock 24, activator wedge 26, separation plate 28 and the like. As such, having the same or similar components as is described herein, bar clamp 200 opens and closes, locks and unlocks in the same or a similar manner to that described herein.

Bench clamp system 210 differs from the free hand clamp system 10 and the bar clamp system 200 in that the lower clamp arm 14 is not present in the bench clamp system 201. Instead, bench clamp system 210 only includes an upper clamp arm 12 and includes a block 212 connected to the lower handle 22 that includes a protrusion 214 or other connecting mechanism. Protrusion 214 or other connecting member is connected to a work bench, platform or other work surface and is used to clamp workpieces against the surface of the work bench. In one arrangement, protrusion 214 connects to a slot of a rail connected to a work surface and upper clamp arm 12 extends outward over the work surface. In this arrangement, when upper handle 20 and lower handle 22 are activated, this pulls upper clamp arm 12 downward into contact with a workpiece on the work surface and presses the workpiece against the work surface thereby holding workpiece in place. This enables bar clamp system 200 to clamp workpieces having a wide range of widths. Other than these differences, the self-adjusting clamping mechanism of bench clamp 210 operates in a similar if not identical manner described above with respect to the free hand clamp system 10.

Pliers, Wrench, Other Tools:

While the term “clamp” is used consistently herein, this term is not meant to be limiting. Instead, the term “clamp” is to be construed in a broad sense and should include any tool that clamps or applies pressure. This includes any pliers, wrench or other device that has one or a pair of jaws (clamp arms) that apply clamping pressure to a workpiece, part or other object.

Accordingly, from the above discussion it will be appreciated that the improved self-adjusting clamp system and method of use presented offers many advantages over the prior art. Specifically, the improved self-adjusting clamp system and method of use improves upon the present state of the art; is simple to use; is easy to use; can be used in association with a work bench or as a free hand tool; is safe to use; provides new and additional ways of using a clamp; allows for added flexibility of use; can be used with a wide array of work processes; can be used in a wide array of industries; can be used with a wide array of work piece thicknesses, quickly and easily; has a robust design; is forgiving; that is durable; that has a long useful life; that has an intuitive design; that improves the speed and ease of performing work processes; among countless other improvements and advantages.

It will be appreciated by those skilled in the art that other various modifications could be made to the device without parting from the spirit and scope of this invention. All such modifications and changes fall within the scope of the claims and are intended to be covered thereby.

What is claimed:

1. A self-adjusting clamp system comprising:
an upper clamp arm;
an upper handle;
a lower handle;
the upper clamp arm, upper handle and lower handle operatively connected to one another so as to reciprocate between an open position and a closed position;
the lower handle having a hollow interior with a curved upper surface;
a wedge lock positioned within the hollow interior of the lower handle;
the wedge lock having a curved upper surface; and
wherein the curved upper surface of the wedge lock fits within the curved upper surface of the hollow interior of the lower handle.

2. The self-adjusting clamp system of claim 1, further comprising a lower clamp arm operatively connected to the lower handle.

3. The self-adjusting clamp system of claim 1, wherein the radius of curvature of the upper surface of the wedge lock is smaller than the radius of curvature of the upper surface of the hollow interior so as to facilitate self-centering of the wedge lock within the hollow interior.

4. The self-adjusting clamp system of claim 1, further comprising a separation plate and an activator wedge positioned within the hollow interior of the lower handle, wherein the separation plate and the activator wedge are positioned below the wedge lock.

5. The self-adjusting clamp system of claim 1, further comprising an adjustment pin connected to a forward end of the wedge lock.

6. The self-adjusting clamp system of claim 1, further comprising a hollow bore positioned in a rearward end of the wedge lock and a return spring positioned within the hollow bore.

7. The self-adjusting clamp system of claim 1, wherein the hollow interior of the lower handle is formed between a pair of opposing handle sides and opposing floor plate and center portion.

8. A self-adjusting clamp system comprising:
an upper clamp arm;
an upper handle;
a lower handle;
the upper clamp arm operatively connected to the upper handle and the lower handle so as to reciprocate between an open position and a closed position;
the lower handle extending a length between a forward end and a rearward end;
the lower handle having a hollow interior that defines an axis of reciprocation;
a floor plate extending a length and defining a plane; and
wherein the plane of the floor plate angles away from the axis of reciprocation as it extends toward the rearward end of the lower handle.

9. The self-adjusting clamp system of claim 8, further comprising wherein the floor plate is connected to the lower handle.

10. The self-adjusting clamp system of claim 8, further comprising wherein the floor plate is connected to the lower handle, and wherein the floor plate and the lower handle are welded together.

11. The self-adjusting clamp system of claim 8, further comprising wherein the floor plate is connected to the lower handle, and wherein the floor plate and the lower handle are formed of a single unitary piece.

12. The self-adjusting clamp of claim 8, further comprising a lower clamp arm operatively connected to the lower handle.

13. The self-adjusting clamp of claim 8, further comprising a wedge lock, separation plate and activator wedge positioned within the hollow interior of the lower handle.

14. The self-adjusting clamp of claim 8, wherein a wedge lock and activator wedge are slidably positioned within the hollow interior and reciprocate between a forward most position and a rearward most position along the axis of reciprocation.

15. The self-adjusting clamp of claim 8, wherein the plane of the floor plate angles away from the axis of reciprocation at an angle of between one degree and parallel.

16. The self-adjusting clamp of claim 8, wherein the plane of the floor plate angles away from the axis of reciprocation at an angle of between half a degree and parallel.

17. The self-adjusting clamp of claim 8, wherein the plane of the floor plate angles away from the axis of reciprocation at an angle of between a quarter of a degree and parallel.

18. The self-adjusting clamp of claim 8, wherein the plane of the floor plate angles away from the axis of reciprocation at an angle of between a tenth of a degree and parallel.

19. The self-adjusting clamp of claim 8, wherein the plane of the floor plate angles away from the axis of reciprocation at an angle of between nine hundredths of a degree and five hundredths of a degree.

20. A self-adjusting clamp system comprising:
an upper clamp arm;
an upper handle;
a lower handle;
the upper clamp arm, upper handle and lower handle operatively connected to one another so as to reciprocate between an open position and a closed position;
the lower handle having a hollow interior that defines an axis of reciprocation;
a wedge lock positioned within the hollow interior of the lower handle;
an activator wedge positioned within the hollow interior of the lower handle;
a lever connected to the activator wedge;
the lever extending between a forward end and a rearward end; and
the rearward end of the lever having a first cam surface and a second cam surface to facilitate clamping.

21. The self-adjusting clamp of claim 20, further comprising a lower clamp arm operatively connected to the lower handle.

22. The self-adjusting clamp of claim 20, wherein the first cam surface and second cam surface operatively engage the wedge lock during a clamping operation.

23. The self-adjusting clamp of claim 20, further comprising an adjustment pin positioned between the wedge lock and the first cam surface and second cam surface of the lever.

24. The self-adjusting clamp of claim 20, wherein the first cam surface operatively engages the wedge lock in an open position.

25. The self-adjusting clamp of claim 20, wherein the second cam surface operatively engages the wedge lock in a closed position.

26. The self-adjusting clamp of claim 20, wherein operative engagement between the lever and the wedge lock transitions from the first cam surface to the second cam surface as the clamp is closed.

27. A self-adjusting clamp system comprising:
an upper clamp arm;
an upper handle;
a lower handle;
the upper clamp arm, upper handle and lower handle operatively connected to one another so as to reciprocate between an open position and a closed position;
the lower handle having a hollow interior;
a wedge lock positioned within the hollow interior of the lower handle;
an activator wedge positioned within the hollow interior of the lower handle;
a lever connected to the activator wedge; and
the lower handle having a cam surface that engages a portion of the upper handle in the closed position.

28. The self-adjusting clamp system of claim 27, further comprising a lower clamp arm operatively connected to the lower handle.

29. The self-adjusting clamp system of claim 27, wherein the cam surface on the lower handle stops the upper handle at an over-center condition across a range of workpiece thicknesses.

30. The self-adjusting clamp system of claim 27, wherein three pivot points connect the upper clamp arm, upper handle, lever and activator wedge and an over-center condition occurs when the center pivot point moves past liner alignment with the other two pivot points.
